(19) United States
(12) Patent Application Publication
(10) Pub. No.: US 2023/0373117 A1
(43) Pub. Date: Nov. 23, 2023

(54) WET SHAVING CARTRIDGE

(71) Applicant: ACCUTEC, INC., Verona, VA (US)

(72) Inventors: Randall N. Herman, Waynesboro, VA (US); Frank H. Prochaska, Waynesboro, VA (US)

(21) Appl. No.: 18/136,707

(22) Filed: Apr. 19, 2023

Related U.S. Application Data
(60) Provisional application No. 63/332,427, filed on Apr. 19, 2022.

(51) Int. Cl. B26B 21/40

(52) U.S. Cl. CPC B26B 21/4031; B26B 21/4018; B26B 21/4025

(57) ABSTRACT

In a first aspect of the subject invention, a wet shaving cartridge is provided herein having bent razor blades each having a constant cross-sectional thickness in the range of 0.005 inches to 0.010 inches, which is thicker than found in the prior art. This provides for a bent blade wet shaving cartridge with razor blades of good rigidity but without the waste, or need for welding, as found with planar razor blades.

### CROSS-REFERENCE TO RELATED APPLICATION

This application claims priority to U.S. Provisional Patent Appl. No. 63/332,427, filed Apr. 19, 2022, the entire contents of which are incorporated by reference herein.

### BACKGROUND OF THE INVENTION

Wet shaving cartridges are well known in the prior art. Such cartridges include a housing having a guard, a cap, and a pair of side walls extending between the guard and the cap. The guard, cap, and side walls collectively define a well in which are arranged a plurality of spaced-apart, parallel blades. The blades may be unitary bent razor blades, such as that shown in U.S. Pat. No. 8,359,752, which is incorporated by reference herein. Alternatively, the blades may be planar razor blades each attached by laser welding to a thicker bent blade support and generally referred to as “welded razor blades”, such as that shown in U.S. Pat. No. 8,726,519, which is incorporated by reference herein.

Bent razor blades have been typically formed from 1 mm stock, which is approximately equal to 0.004″ thickness. Intermediate supports may be needed on the housing at one or more mid-points along the width of the well, which extend between the guard and the cap, to impart rigidity to the bent blades during use.

The planar blade segments of welded razor blades are also relatively thin (typically 0.003″ or 0.004″ thick), but supported by thicker, more robust blade supports which impart greater rigidity than found with typical bent blades. The blade supports may be a different grade of steel than the planar blade segments being welded thereon. A significant issue with this arrangement is waste, particularly due to the planar blade segments being taken from a wider stock material. For example, 0.226″ wide stock may be reduced to 0.040″ width in forming the planar blade segments, thereby losing 0.186″ width of the material as scrap. Likewise, the production of the blade supports produces a significant percentage of scrap, and welding also adds cost to the processing of these blades along with the need for specialized capital equipment.

### SUMMARY OF THE INVENTION

In a first aspect of the subject invention, a wet shaving cartridge is provided herein having bent razor blades each having a constant cross-sectional thickness in the range of 0.005 inches to 0.010 inches, which is thicker than found in the prior art. This provides for a bent blade wet shaving cartridge with razor blades of superior rigidity but without the waste, or need for welding, as found with welded razor blades.

In a further aspect of the subject invention, a wet shaving cartridge is provided having bent razor blades with asymmetrical cutting edges. The cutting edges are off-center on the thickness of the bent razor blades, being each defined by two different-length, converging facets. The asymmetrical arrangement provides an advantage for good flow-through of shaving debris, while providing a familiar appearance to users.

These and other features of the subject invention will be better understood through a study of the following detailed description and accompanying drawings.

### BRIEF DESCRIPTION OF THE FIGURES

FIG. 1 is a perspective view of a typical shaving razor having a wet shaving cartridge mounted thereto;

FIG. 2 is a cross-section taken along line 2-2 of FIG. 1;

FIG. 3 shows bent razor blades for a wet shaving cartridge formed in accordance with the subject invention;

FIG. 4 shows a bent razor blade formed in accordance with the subject invention in a shaving position against the base of a one-day growth of hair;

FIGS. 5-6 show bent razor blades formed in accordance with the subject invention having different bend radii;

FIG. 7 shows bent razor blades arranged to have negative and positive exposure;

FIG. 8 shows a possible arrangement of bent razor blades in a wet shaving cartridge in accordance with the subject invention; and,

FIGS. 9-10 show a bent razor blade with an asymmetrical cutting edge in accordance with the subject invention.

### DETAILED DESCRIPTION

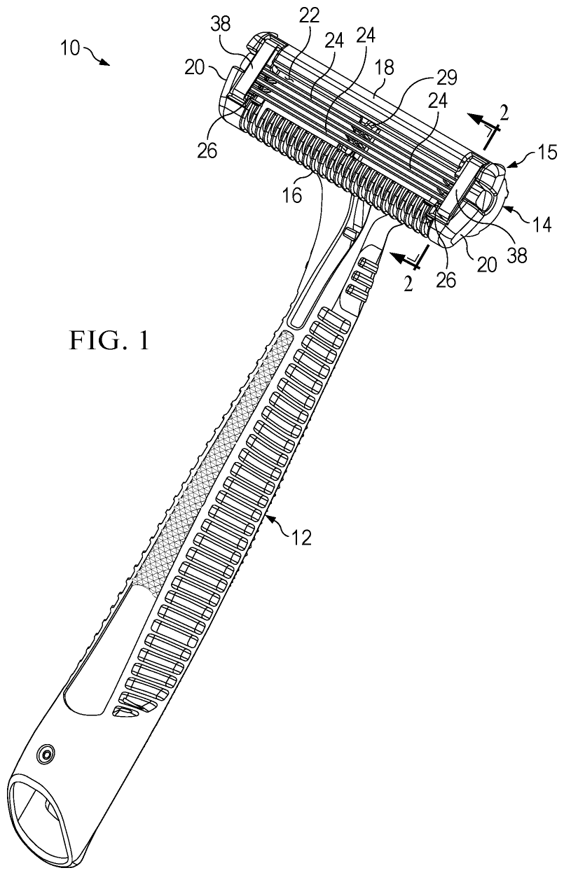

With reference to FIG. 1, a shaving razor 10 is shown generally having a handle 12 to which is mounted a wet shaving cartridge 14. The wet shaving cartridge 14 may be mounted to the handle 12 in any known manner, including being fixedly mounted, so as to not be removable, thereby providing the shaving razor 10 as a disposable razor, or removably mounted, to allow for cartridge replacement and re-use of the handle 12. In addition, as is known in the art, the wet shaving cartridge 14 may be pivotally mounted to the handle 12 to allow the wet shaving cartridge to react to the contours of a person's face, or other body location, during shaving.

The wet shaving cartridge 14 includes a housing 15 with a guard 16, a cap 18, and a pair of side walls 20 extending between the guard 16 and the cap 18. The guard 16, the cap 18, and the side walls 20 collectively bound a well 22. A plurality of blades 24 is arranged in parallel within the well 22 to extend between interior portions 26 of the side walls 20. Various quantities of the blades 24 may be utilized.

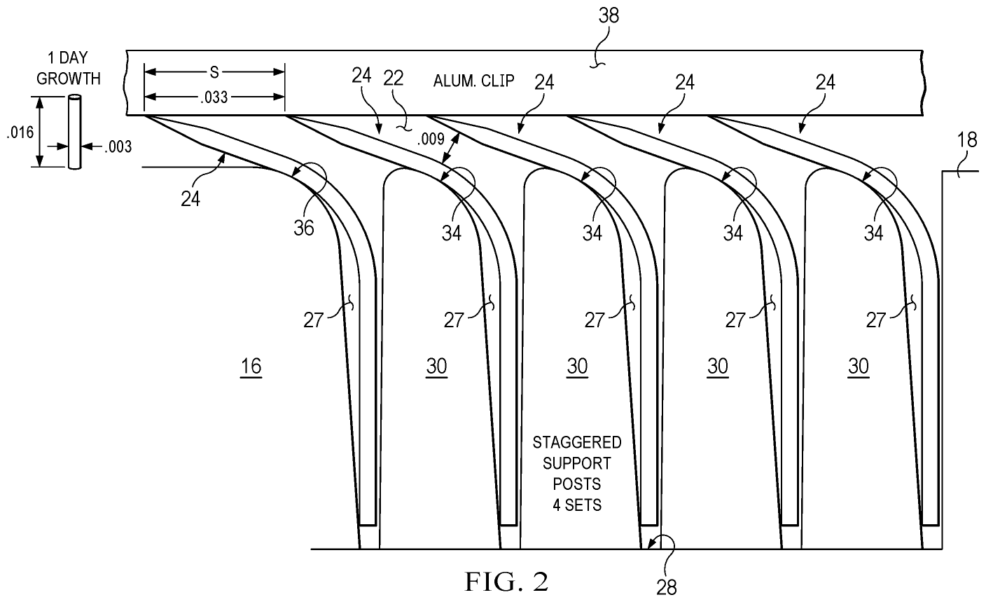

FIG. 2 shows a cross-section of a typical, prior art wet shaving cartridge utilizing bent blades. As shown in FIG. 2, the interior portions 26 of the side walls 20 may each include a base surface 28 from which upwardly protrude spaced-apart blade retention members 30. The blade retention members 30 each include a body 32, with the bodies 32 being spaced apart to define channels 27 to receive lower portions of the blades 24. The channels 27 are each preferably convergently tapered towards the base surface 28 to taper down to the thickness of an individual blade 24 or slightly less than the thickness of an individual blade 24, thereby providing a conformal or interfering fit for the blade 24. This fit limits relative movement between the blades 24 and the housing 15 at points of contact. The blade retention members 30 also each include a curved free end 34 contoured for limited contact with the blades 24. The guard 16 may have an inner edge 36 contoured in similar fashion as the curved free ends 34. The guard 16 may also define a channel 27 with the adjacentmost blade retention member 30. Likewise, the cap 18 may define a channel 27 with the adjacentmost blade retention member 30. In this manner, the guard 16 and the cap 18 coact with the blade retention members 30 to retain the blades 24 and to limit relative movement thereof.

The blades 24 extend between the blade retention members 30 of both of the side walls 20, across the width of the wet shaving cartridge 14. As is known in the art, clips 38 may be provided to retain the blades 24. The clips 38 may be metal, plastic, or a combination thereof, and may be snap fit, press fit, glued or ultrasonically welded to the housing 15, e.g., along the side walls 20. In addition, one or more intermediate supports 29 may be provided with the housing 15 which are strip-shaped to extend between the guard 16 and the cap 18 spanning across a mid-location of the well 22. Each intermediate support 29 may include a base surface 28 and blade retention members 30 as formed on the interior portions 26 of the side walls 20. The intermediate supports 29 provide mid-span support to the blades 24, if needed.

The subject invention may utilize the same basic arrangement as shown in FIGS. 1 and 2, but with the differences noted as follows. For the subject invention, it is preferred that the well 22 be maximally left open to allow for flow-through of shaving debris. With the subject invention, it is preferred that a limited number of intermediate supports, more preferably, no intermediate supports, be utilized.

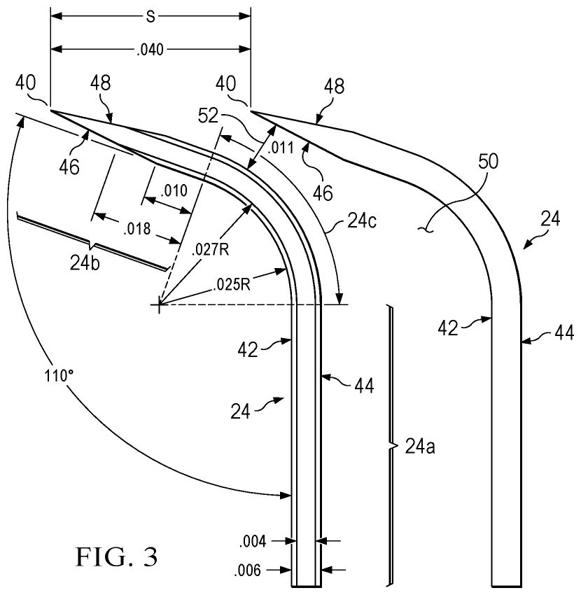

As shown in FIG. 3, for the subject invention, each of the blades 24 is elongated with a generally constant cross-section which includes a first straight section 24a, a second straight section 24b, and a third curved section 24c extending between the first and second straight sections 24a, 24b. The blades 24 are each unitarily formed from a single blank of metal, such as surgical-grade hardenable stainless steel (e.g., modified SAE 440). The single metal blank has a thickness in the range of about 0.005 inches to about 0.010 inches. Thus, as a result, each of the blades 24 generally has a uniform thickness throughout its cross-section, in particular, with the thickness of the first straight section 24a, the second straight section 24b, and the third curved section 24c being constant throughout in the range of about 0.005 inches to about 0.010 inches. During manufacturing, the blades 24 are bent to form the third curved sections 24c, possibly resulting in some thinning about the third curved sections 24c. The difference in thickness resulting from thinning is expected to be negligible. By way of non-limiting example, each of the blades 24 may be formed from a single metal blank of 0.006 inch thickness, resulting in a finished cross-sectional thickness of 0.006 inches along the first through third sections 24a-24c of the blades 24.

As assembled, the first straight sections 24a of the blades 24 are received in the channels 27 between pairings of: the guard 16 and an adjacentmost of the blade retention members 30; two adjacent blade retention members 30; and, the cap 18 and an adjacentmost of the blade retention members 30. For each of the blades 24, the second straight section 24b extends away from the base surface 28 to a free edge 40 which defines a cutting edge. In particular, the blade 24 includes an interior face 42, about which the blade 24 is bent, and an exterior face 44, opposite the interior face 42. A first facet 46 is defined on the interior face 42 along the free edge 40, and a second facet 48 is defined on the interior face 42 along the free edge 40. The first and second facets 46, 48 are tapered to converge to define the free edge 40 as a cutting edge.

The free edges 40 of the blades 24 are spaced apart across the well 22, in a direction between the guard 16 and the cap 18, to define a span S between each pair of adjacent blades 24. The span S may be the same for each pair of adjacent blades 24, e.g., being 0.040 inches as shown in FIG. 3. A flow-through channel 50 extends between each pair of adjacent blades 24 from the span S to provide a flow path through the well 22 and away from the free edges 40 for shaving debris. The narrowest portion of each of the flow-through channels 50 defines a throat 52 which may act as the greatest restriction against passage of shaving debris and, thus, may be a critical dimension. With the arrangement of FIG. 3, the throat 52 is shown to be 0.011 inches.

Significantly, the blades 24 shown in FIG. 3 are bent razor blades with greater thickness than found with typical bent razor blades, such as those shown in FIG. 2. In FIG. 3, the blade 24, on the left, is shown superimposed over a standard, prior-art bent razor blade of 0.004 inch thickness. With the blades 24 of the subject invention each having a 0.006 inch thickness, this represents a 50% increase in thickness over the prior art, which imparts an even greater resistance to bending and torsion (2.25× increase). In addition, each of the blades 24 of the subject invention is able to achieve, relative to the standard, prior art wet shaving cartridge as shown in FIG. 2, a relatively large span S and increased width of the throat 52 of the flow-through channel 50 (for the span S, 0.040 inches vs. 0.033 inches; for throat width, 0.011 inches vs. 0.009 inches).

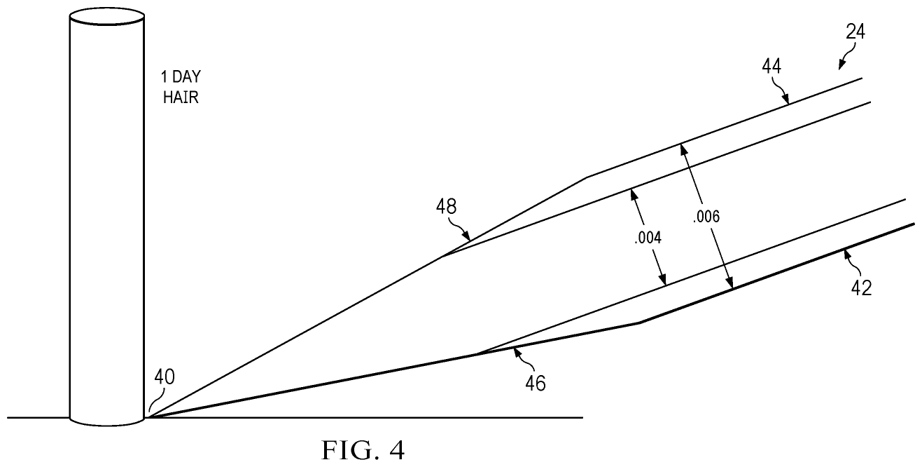

FIG. 4 shows the blade 24 of the subject invention formed as described above in connection with FIG. 3, superimposed over a prior art blade of 0.004 inches. In addition, FIG. 4 shows a length of hair equivalent to a typical one-day growth. Significantly, as shown in FIG. 4, the blade 24, in spite of having greater thickness than the prior art, is equally effective in causing cutting removal of the hair as the prior art blade. In other words, the free edge 40 of the blade 24 extends to the base of the hair in the same manner as the prior art blade. The free edge 40 of the blade 24 of the subject invention coincides with the cutting edge of the prior art blade at the base of the hair.

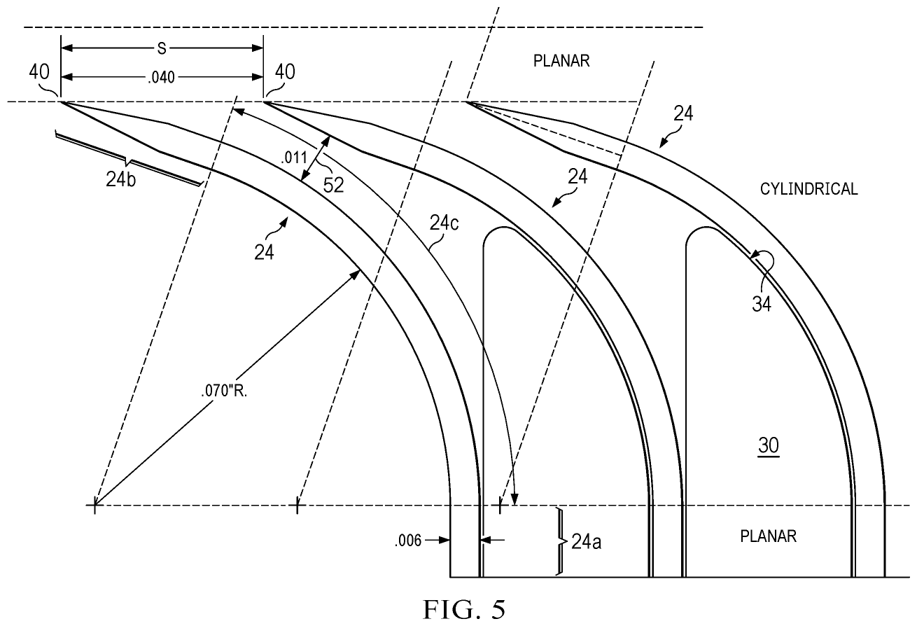

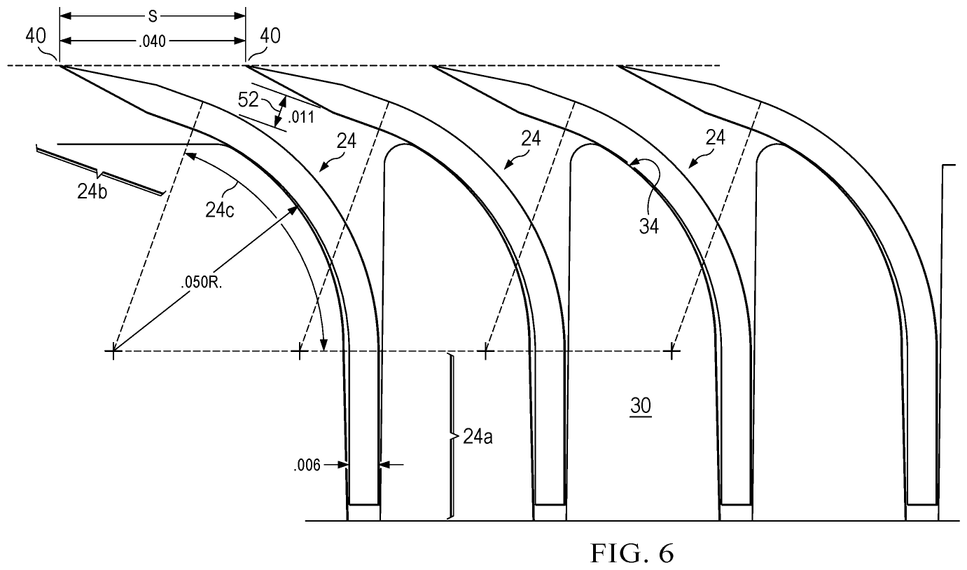

As shown in FIGS. 5 and 6, the bend radius of the third curved section 24c may need to be increased, compared to the prior art as shown in FIG. 3 (0.027 inches), due to the increased cross-sectional thickness. The need or selection of a bend radius may be affected by multiple variables including: the constituent material of the blade 24 (e.g., grade of metal); manner of heat treating the blade 24; manner of edge finishing the blade 24 (e.g., forming the first and second facets 46, 48); and manner by which the blade 24 is bent. FIG. 5 shows the third curved section 24c with a radius of 0.070 inches, while FIG. 6 shows the third curved section with a radius of 0.050 inches. Both FIGS. 5 and 6 show the blade 24 with a cross-sectional thickness of 0.006 inches. The blade 24 may have a cross-sectional thickness in the range of 0.005 inches to 0.010 inches. As will be noted, with an increase in radius of the third curved section 24c, the length of the first and second straight sections 24a, 24b are proportionately shortened. In addition, the blade retention members 30 and the guard 16 may be contoured to the increased length of the third curved section 34c with the channels 27, the curved free ends 34, and the inner edge 36 being conformably shaped to the corresponding bend radius.

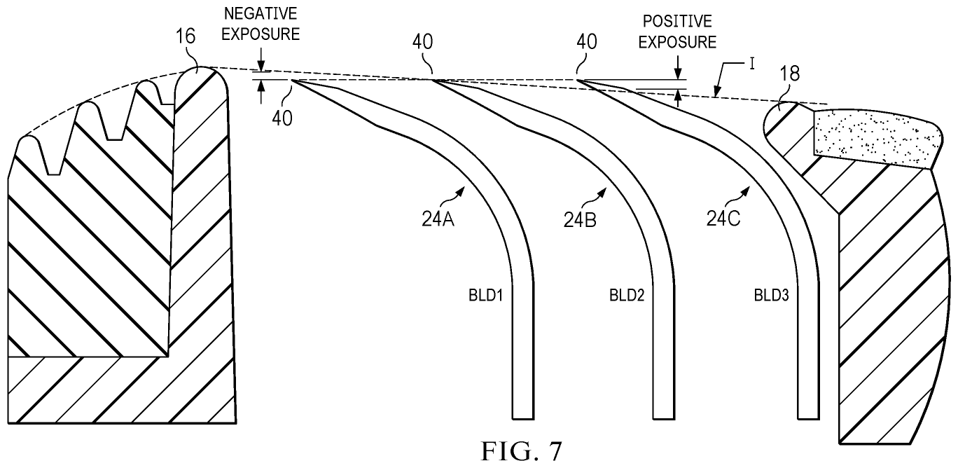

The curved free ends 34 of the blade retention members 30 and the inner edge 36 of the guard 16 are contoured to provide limited contact with the interior faces 42 of the blades 24 with the free edges 40 being unsupported beyond the curved free ends 34. In this manner, torsion of the blades 24 is limited with the free edges 40 being deflectable. This allows for the free edges 40 to resiliently conform to the contours of the user's face or body, providing a more comfortable shave. The extent to which the free edges 40 extend beyond the curved free ends 34 may vary. As is known in the art, consideration is given to the height of the free edges 40 relative to the guard 16 and the cap 18. As shown in FIG. 7, the free edges 40 may be located to be “positive” or “negative” relative to one or both of the guard 16 and the cap 18. For example, if the blade 24 most adjacent to the guard 16 protrudes higher than the guard 16, the blade 24 is considered to have a positive exposure; in contrast, if the guard 16 protrudes higher than the same blade 24, the blade 24 is considered to have a negative exposure. The same notion may apply to each of the blades 24 relative to the guard 16 and the cap 18 and relative to an imaginary plane I extending across the tops of the guard 16 and the cap 18, with exposure possibly varying between the blades 24 (e.g., the blade 24A having a negative exposure; the blade 24B being neutral (even with the plane I); and, blade 24C having a positive exposure). The setting of positive and negative exposure allows for establishing comfort for a user while providing a good shave.

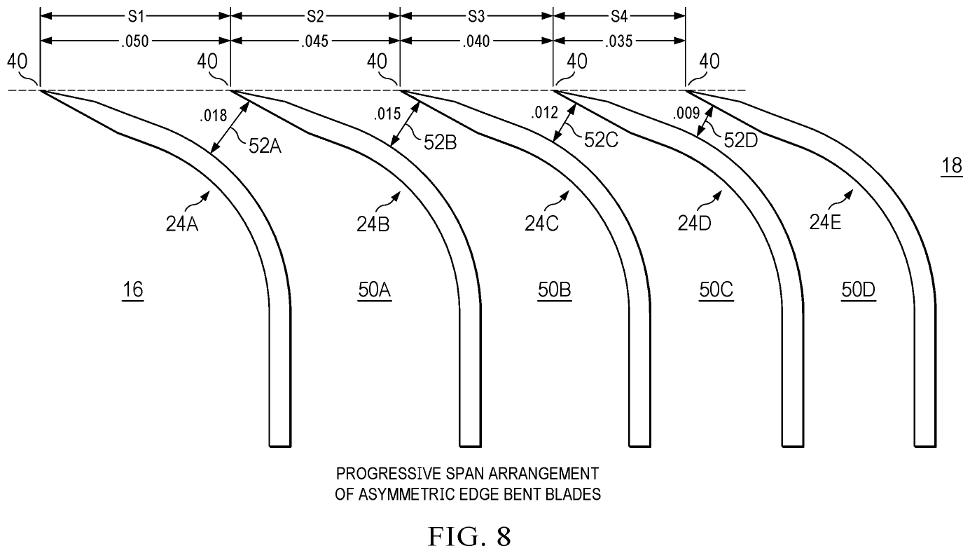

The span S between pairs of adjacent blades 24 may be varied in connection with positive and negative exposure of the blades 24. With reference to FIG. 8, progressively increasing spans may be used in a direction from the guard 16 to the cap 18. As shown in FIG. 8, spans S1, S2, S3, S4 may be utilized which decrease in equal intervals in a direction from the guard 16 to the cap 18. As shown in FIG. 8, the spans S1, S2, S3, S4 may decrease in 0.005 increments. In this manner, the flow-through channel 50A defined between adjacent blades 24A, 24B is the largest. Shorter spans are known to provide increased comfort to a user but suffer from greater clogging due to reduction in size of the corresponding flow-through channel. With decreasing the spans S1, S2, S3, S4 in equal intervals, greater flow-through is provided at the beginning portion of a shaving stroke, with greater comfort (with less flow-through) being provided at the ending portion of the same shaving stroke. Due to the decreasing size of the spans S1, S2, S3, S4, the flow-through channels 50A, 50B, 50C, 50D, along with the corresponding throats 52A, 52B, 52C, 52D, likewise decrease in size.

The spans S1, S2, S3, S4 may be varied in other patterns, where, for example, two or more of the spans are the same size, e.g., S1>S2, S3>S4 with S2=S3. FIG. 8 depicts the use of five blades 24A-24E, but other quantities are possible, with corresponding quantities of spans being defined. The spans S1, S2, S3, S4 may be arranged to increase in size, in even or uneven increments in a direction from the guard 16 to the cap 18. The spans S1, S2, S3, S4 may be also arranged in other non-constant patterns.

In addition, the level of exposure of the blades 24 may be varied along with use of unequal spans S. For example, with reference to FIG. 8, the blades 24A, 24B may have a negative exposure relative to the guard 16 while the blades 24D, 24E may have a positive exposure relative to the guard 16. The blade 24C may have an exposure therebetween, including possibly having no exposure (being even with the top of the guard 16). With this arrangement, negative exposure of the leading blades 24A, 24B offsets the greater span S1 therebetween when shaving, while, positive exposure of the trailing blades 24D, 24E offsets the smaller span S4 therebetween. This allows for good flow-through with user comfort.

It is noted that the varying of spans, optionally with varying exposure, may be used with the blade 24 described above having a cross-sectional thickness in the range of 0.005 inches to 0.010 inches. In addition, the varying of spans, optionally with varying exposure, may be used with bent blades for wet shaving cartridges of other cross-sectional thicknesses.

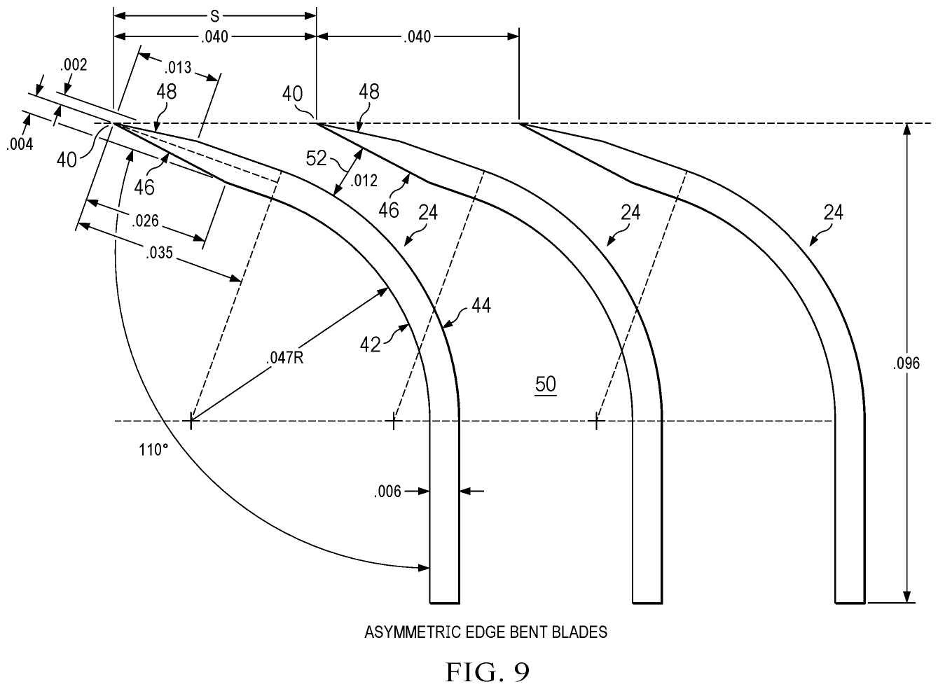

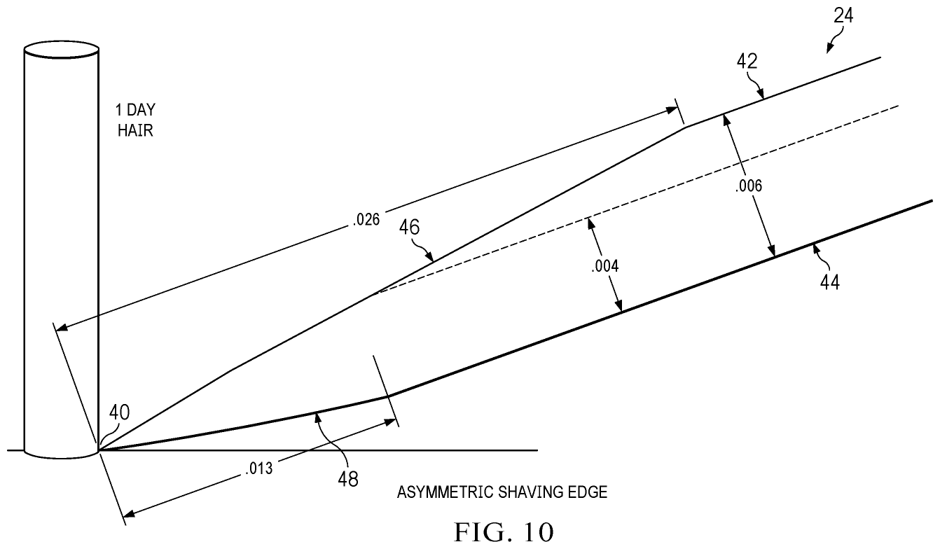

With reference to FIGS. 9-10, the lengths of the first facet 46 and the second facet 48 may be varied with the free edge 40 being asymmetrical. In particular, the first facet 46 may be provided with a greater length than the second facet 48. In this manner, the second facet 48, which is viewable by a user, may mimic the size of standard, prior art bent blade facets, e.g., as shown in FIG. 2. In addition, this arrangement can be used with the blade 24 having a cross-sectional thickness in the range of 0.005 inches to 0.010 inches with the longer first facet 46 extending over a greater portion of the cross-sectional thickness. Due to the asymmetrical arrangement, the free edge 40 is located off-center closer to the exterior face 44 than the interior face 42. In addition, due to the increased length of the first facet 46, the first facet 46 overlaps a greater length of the exterior face 44 of an adjacent blade 24. This allows for a larger throat 52 being defined due to the set-back of the first facet 46. With the arrangement of FIG. 9, the throat 52 is 0.012 inches.

With reference to FIG. 10, the asymmetric configuration of the free edge 40 does not impede access to hair for shaving. The free edge 40 is able to reach the base of the hair equally as well as a symmetrical configuration of the free edge 40.

It is noted that the asymmetric configuration of the free edge may be used with the blade 24 described above having a cross-sectional thickness in the range of 0.005 inches to 0.010 inches. In addition, the asymmetric configuration of the free edge may be used with bent blades for wet shaving cartridges of other cross-sectional thicknesses.

What is claimed is:

1. A wet shaving cartridge comprising:
a housing including a guard, a cap, and a pair of side walls extending between the guard and the cap, an open well being bounded by the guard, the cap, and the side walls, wherein, a plurality of blade retention members are defined on interior portions of the side walls; and,
a plurality of blades arranged in parallel within the well to extend between the blade retention members of the side walls, the blades each including a first straight section, a second straight section, and a third curved section extending between the first and second straight sections, the first straight section having opposing ends adjacent to at least one of the blade retention members of each of the side walls, a free edge of the second straight section defining a cutting edge, wherein, the blades are each unitarily formed from a single metal blank to have a constant cross-sectional thickness in the range of about 0.005 inches to about 0.010 inches.

2. The wet shaving cartridge of claim 1, wherein each of the plurality of blades is unitarily formed from a single blank of metal.

3. The wet shaving cartridge of claim 1, wherein each of the blade retention members includes a curved free end contoured to the third curved section of an adjacent blade.

4. The wet shaving cartridge of claim 1, wherein the third curved section of each of the plurality of blades has a radius of 0.050 inches.

5. The wet shaving cartridge of claim 1, wherein the third curved section of each of the plurality of blades has a radius of 0.070 inches.

6. The wet shaving cartridge of claim 1, wherein a first blade is located adjacentmost to the guard, a second blade is located adjacent to the first blade, a third blade is located adjacent to the second blade, and a fourth blade is located adjacent to the third blade, wherein a first span is defined between the first blade and the second blade, a second span is defined between the second blade and the third blade, and a third span is defined between the third blade and the fourth blade.

7. The wet shaving cartridge of claim 6, wherein the first span is greater than the second span, and the second span is greater than the third span.

8. The wet shaving cartridge of claim 7, wherein the difference between the first span and the second span is equal to the difference between the second span and the third span.

9. The wet shaving cartridge of claim 6, wherein the first span is greater than the second span, with the second span being equal to the third span.

10. The wet shaving cartridge of claim 7, wherein the first blade has negative exposure.

11. The wet shaving cartridge of claim 10, wherein the fourth blade has positive exposure.

12. The wet shaving cartridge of claim 1, wherein, for each of the blades, the cutting edge being asymmetric, defined by facets on opposing faces of the blade of different widths.

13. The wet shaving cartridge of claim 1, wherein, each of the blades including an interior face, about which the respective blade is bent, and an exterior face opposite the interior face, the interior face generally facing in the direction of the guard.

14. The wet shaving cartridge of claim 13, wherein, for each of the blades, a first facet being defined on the exterior face along the free edge, a second facet being defined on the interior face along the free edge, the first and second facets being tapered to converge to define the cutting edge, the width of the second facet, as measured perpendicularly away from the free edge, being greater than the width of the first facet, as measured perpendicularly away from the free edge.

15. The wet shaving cartridge of claim 14, wherein, for each of the blades, the exterior face includes a first planar portion adjacent to the first facet, the first planar portion lying in a first plane, wherein the interior face includes a second planar portion adjacent to the second facet, the second planar portion lying in a second plane, and wherein the free edge is generally parallel to both the first and second planes with the free edge being spaced closer to the first plane than the second plane.

16. The wet shaving cartridge of claim 14, wherein a first of the blades is located adjacent to a second of the blades so that a flow-through channel is defined between the exterior face of the first blade and the interior face of the second blade, and wherein the narrowest spacing between the exterior face of the first blade and the interior face of the second blade, along the flow-through channel, coincides with the second facet of the second blade.

17. A shaving razor cartridge comprising:
a handle; and,
a wet shaving cartridge, formed in accordance with claim 1, mounted to the handle.

18. The shaving razor of claim 17, wherein the wet shaving cartridge is fixedly mounted to the handle.

19. The shaving razor of claim 17, wherein the wet shaving cartridge is removably mounted to the handle.

20. The shaving razor of claim 17, wherein the wet shaving cartridge is pivotally mountable to the handle.
